(19) United States
(12) Patent Application Publication
(10) Pub. No.: US 2013/0118873 A1
(43) Pub. Date: May 16, 2013

(54) ELECTRONIC DEVICE HAVING KEY SWITCH

(71) Applicants: XIAO-HUI ZHOU, Shenzhen City (CN); WEI LIU, Shenzhen City (CN); YONG-JUN YU, Shenzhen City (CN); HE-LI WANG, Shenzhen City (CN)

(72) Inventors: XIAO-HUI ZHOU, Shenzhen City (CN); WEI LIU, Shenzhen City (CN); YONG-JUN YU, Shenzhen City (CN); HE-LI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/482,433

(22) Filed: May 29, 2012

(30) Foreign Application Priority Data
Nov. 14, 2011 (CN) 201110359084.4

(51) Int. Cl. H01H 13/02

(52) U.S. Cl. 200/341

(57) ABSTRACT

An electronic device includes a body, a key switch and a limiting mechanism secured to the body. The body includes a top wall defining an aperture. The key switch includes a touch switch, an actuating member for actuating the touch switch when being pressed, and a key cap received in the aperture and abutting the actuating member. The limiting mechanism corresponds to the aperture. When the key cap is pressed, the actuating member is driven to actuate the touch switch, and the limiting mechanism limits the movement of the key cap to protect the touch switch from damages.

### BACKGROUND

1. Technical Field

The present disclosure relates to electronic devices; and particularly to an electronic device having a key switch.

2. Description of Related Art

Electronic device, such as a DVD player, includes a body and a plurality of key switches secured to the body. Each key switch includes a key cap, and an actuating member corresponding to a touch switch of a circuit board. The key cap is pressed to make the actuating member to contact with the corresponding touching switch of the circuit board. However, after the actuating member contacts with the touch switch, if the key cap is pressed with an excessive force, the touch switch of the circuit board may be damaged.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the four views.

FIG. 1 is a perspective view of an electronic device having a body in accordance with an embodiment.

FIG. 2 is a partially disassembled perspective view of the body of the electronic device in FIG. 1; the body includes a top case and a bottom case.

FIG. 3 is a perspective view of the top case in FIG. 2, but viewed from another aspect.

FIG. 4 is a cross-sectional view of the electronic device taken along line IV-IV in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

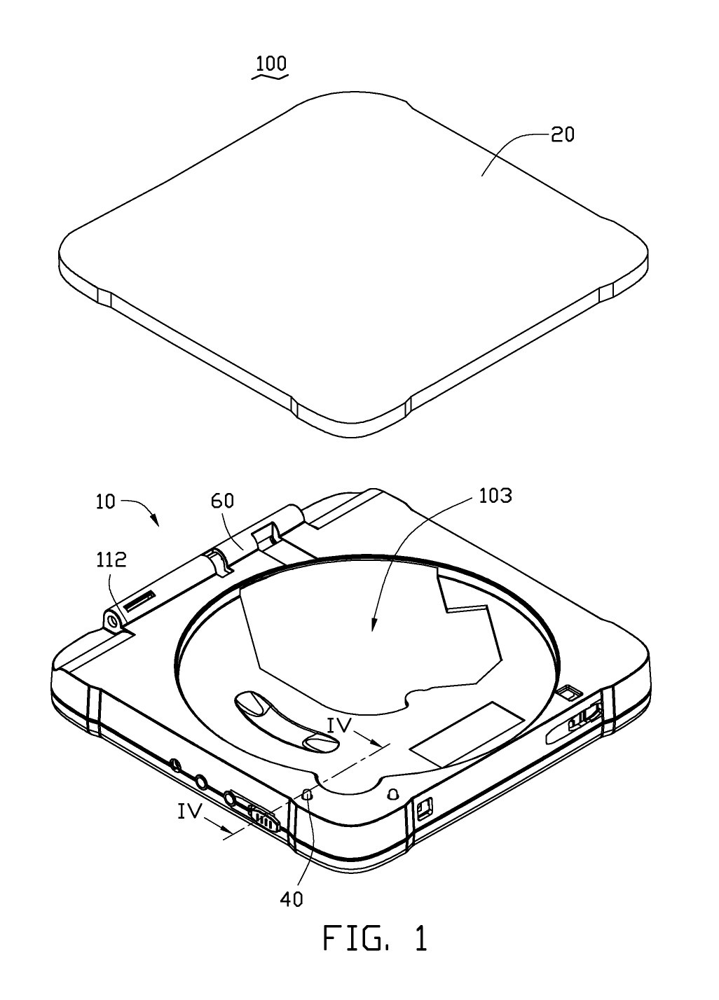

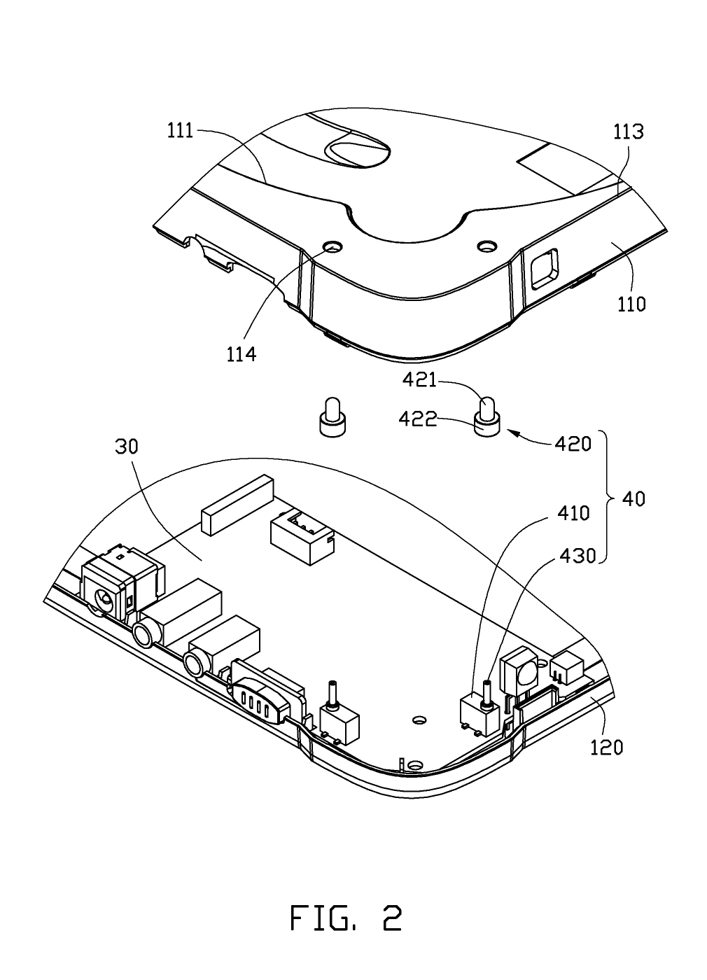

Referring to FIGS. 1-2, a perspective view of an electronic device 100 in accordance with an embodiment is shown. The electronic device 100 includes a body 10, a cover 20 rotatably coupled to the body 10, a circuit board 30 received in the body 10, and two key switches 40 secured to the body and electrically connected to the circuit board 30. The electronic device 100 further includes two limiting mechanisms 50 secured to the body 10. The limiting mechanisms 50 correspond to the respective key switches 40. The limiting mechanisms 50 protect the corresponding key switches 40 from damages when the key switches 40 are pressed. In the embodiment, the electronic device 100 may be a portable disc player. The electronic device 100 further includes a disc cover (not shown) rotatably mounted to the body 10. The disc cover allows the discs (not shown) to be loaded and unloaded when the disc cover is open.

The body 10 is substantially rectangular, and includes a top case 110 and a bottom case 120. The top case 110 engages with the bottom case 120 to define a receiving space 103 for receiving the limiting mechanisms 50, the circuit board 30, and other components (not shown) of the electronic device 100.

The top case 110 includes a top wall 111 and four sidewalls 113 extending from the edges of the top wall 111. The top wall 111 is substantially rectangular, and includes a front rim 113 and a rear rim 112 opposite to the front rim 113. The top wall 111 defines two apertures 114. The apertures 114 are substantially round, and are arranged at a vertex of the top wall 111 adjacent to the front rim 113. A hinge mechanism 60 is arranged at the rear rim 112 of the top wall 111. The cover 20 is rotatably coupled to the hinge mechanism 60.

The circuit board 30 is housed in the body 10, and is substantially parallel to the top wall 111. Connectors, signal receiving unit and other electronic components (not labeled) are mounted on the circuit board 30.

Each key switch 40 includes a touch switch 410 electrically connected to the circuit board 30, a key cap 420, and an actuating member 430 coupled to the touch switch 410. The key cap 420 include an operating portion 421 slideably received in the aperture 114 and an abutting portion 422. The abutting portion 422 is substantially cylindrical, and is fixed to an end of the operating portion 421. The size of the abutting portion 422 is greater than the diameter of the aperture 114. The actuating member 430 abuts an end of the abutting portion 422 opposite to the operating portion 421. The actuating member 430 contacts with the touch switch 410 when the key cap 420 is pressed. In the embodiment, each key switch 40 has a predetermined limit distance, and the key cap 420 is allowed to move within a range of less than the predetermined limit distance to protect the touch switch 410 from damages.

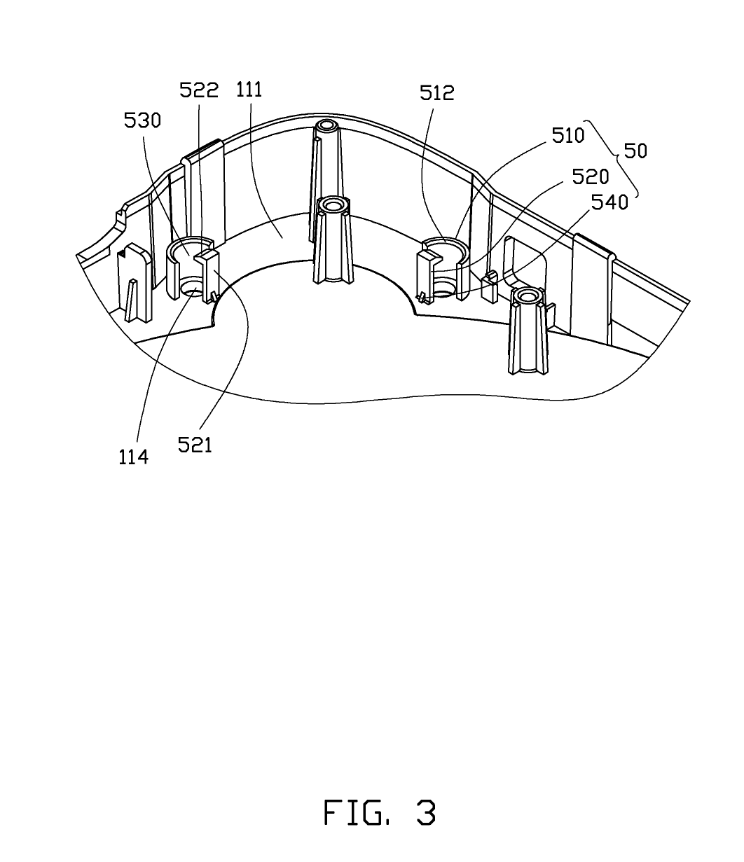

Referring also to FIG. 3, the limiting mechanisms 50 are used to limit the key cap 410 to move within a range of less than the predetermined limit distance. The limiting mechanisms 50 are positioned on an inner surface of the top wall 111 and correspond to the apertures 114 respectively. Each limiting mechanism 50 includes a guiding member 510 and a stopping member 520. The guiding member 510 and the stopping member 520 are arranged at opposite sides of the aperture 114. The guiding member 510 extends perpendicularly from the inner surface of the top wall 111. The horizontal cross-section of the guiding member 510 is substantially C-shaped. The guiding member 510 has a curved surface 512. The curved surface 512 and the aperture 114 are arranged coaxially.

The stopping member 520 includes a cantilever 521 perpendicularly extending from the top wall 111 and a hook 522 bending from an end of the cantilever 521 away from the top wall 111. The cantilever 521 is elastically deformed, and cooperates with the guiding member 510 to define a holding space 530. The holding space 530 slideably receives the actuating member 430 therein and limits the key cap 420 to slide in a direction perpendicular to the top wall 111. The hook 522 extends into the holding space 530, and is used to limit the movement of the key cap 420. The distance between the hook 522 and the top wall 111 is less than the height of the guiding member 510 relative to the top wall 111. In the embodiment, the distance between the hook 522 and the top wall 111 is less than the predetermined limit distance of the key switch 40.

Furthermore, the limiting mechanism 50 further includes a rib 540. The rib 540 protrudes from the inner surface of the top wall 11 and connects with an end of the cantilever 521 opposite to the guiding member 510. The rib 540 is used to enhance the stiffness of the cantilever 521.

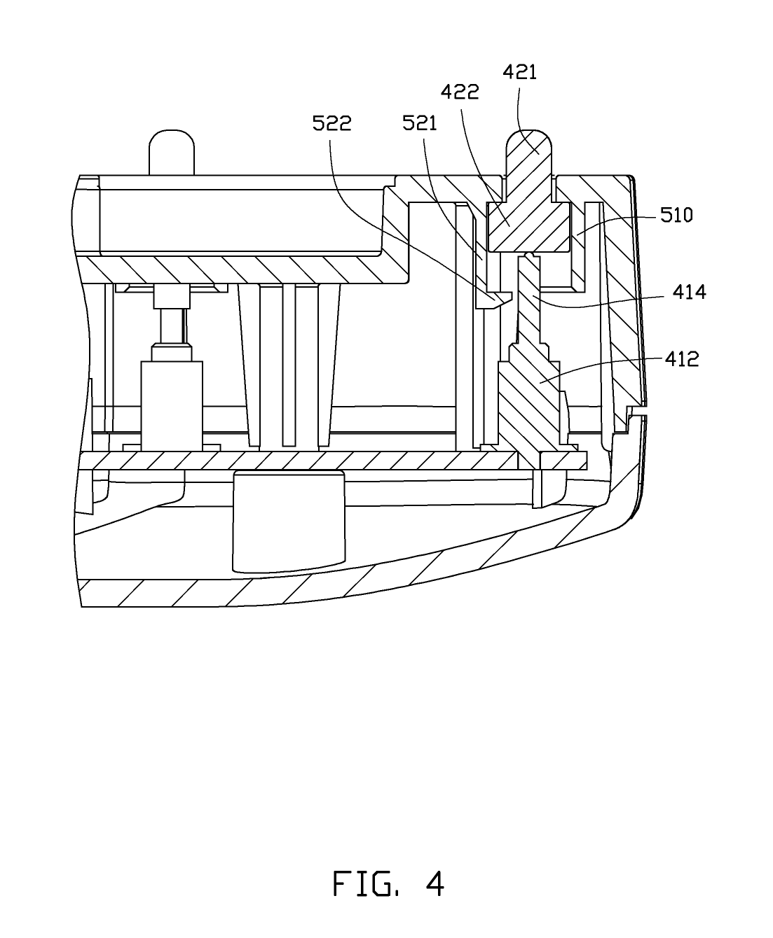

Referring to FIG. 4, in assembly, firstly, the limiting members 520 are elastically deformed, and the key caps 420 are received in the holding spaces 530 with the operating portions 421 being received in the corresponding apertures 114. Secondly, the touch switches 410 are secured to the circuit board 30, and the circuit board 30 is mounted to the bottom case 120. Finally, the bottom case 120 is secured to the top case 110 with abutting portion 422 abutting the inner surface of the top wall 111 and the actuating member 430 abutting the abutting portion 422.

After assembly, as the distance between the hooks 522 and the top wall 111 are less than the limit distance of the key switches 40, the movement of the key caps 420 are limited by the hooks 522, and the touch switches 410 are protected from damages when the key caps 420 are pressed.

It is to be understood, even though information as to, and advantages of, the present embodiments have been set forth in the foregoing description, together with details of the structures and functions of the present embodiments, the disclosure is illustrative only; and that changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a body comprising a top wall, the top wall defining an aperture;
a key switch secured to the body, the key switch comprising a touch switch, an actuating member for actuating the touch switch when being pressed, and a key cap received in the aperture and abutting the actuating member; and
a limiting mechanism secured to the body and corresponding to the aperture;
wherein when the key cap is pressed, the actuating member is driven to actuate the touch switch, and the limiting mechanism limits the movement of the key cap to protect the touch switch from damages.

2. The electronic device of claim 1, wherein the limiting mechanism comprises a guiding member and a limiting member, the guiding member and the limiting member are arranged at opposite sides of the aperture.

3. The electronic device of claim 2, wherein the guiding member cooperates with the limiting member to form a holding space for holding the key cap.

4. The electronic device of claim 3, wherein the limiting member comprises a cantilever extending from the top wall and a hook, the hook bends from an end of the cantilever and extends into the holding space.

5. The electronic device of claim 4, wherein the cantilever is elastically deformed.

6. The electronic device of claim 4, wherein the limiting mechanism further comprises a rib, the rib protrudes form the inner surface of the top wall and connects with an end of the cantilever opposite to the guiding member.

7. The electronic device of claim 4, wherein the distance between the hook member and the top wall is less than the height of the guiding member relative to the top wall.

8. The electronic device of claim 4, wherein the touch switch has a predetermined limit distance, the key cap is allowed to move within a range of less than the predetermined limit distance to protect the touch switch from damages.

9. The electronic device of claim 8, wherein the distance between the hook member and the top surface is less than the predetermined limit distance.

10. The electronic device of claim 3, wherein the key cap comprise an operating portion and an abutting portion fixed to an end of the operating portion, the operating portion is slideably received in the aperture, the abutting portion is slideably received in the holding space.

11. The electronic device of claim 10, wherein the size of the abutting portion is greater than the size of the aperture.

12. The electronic device of claim 10, wherein the actuating member abuts an end of the abutting portion opposite to the operating portion.

13. The electronic device of claim 1, further comprising a circuit board, wherein the circuit board is received in the body and is parallel to the top wall.

14. The electronic device of claim 13, wherein the touch switch is electrically connected to the circuit board.
